(19) United States
(12) Patent Application Publication
(10) Pub. No.: US 2007/0262734 A1
(43) Pub. Date: Nov. 15, 2007

(54) Filament Cutout Circuit

(75) Inventors: Rama Venkat, Aurora, IL (US); Patrick Keegan, La Grange Park, IL (US); Ernesto Mendoza, Elgin, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philps Electronics, N.V.

(21) Appl. No.: 10/565,662

(22) PCT Filed: Jul. 22, 2004
(86) PCT No.: PCT/IB04/51281

§ 371 Date: Nov. 6, 2006

Related U.S. Application Data
(60) Provisional application No. 60/490,003, filed on Jul. 25, 2003.

(51) Int. Cl. H05B 41/295

(52) U.S. Cl. 315/360

(57) ABSTRACT

The invention provides a filament cutout circuit for a fluorescent lamp (60). The filament cutout circuit includes a filament transformer (20) with a primary winding (22) and at least one secondary winding (24, 26, 28), and a cutout transistor (30) serially connected to the primary winding (22). The secondary winding (24, 26, 28) provides a filament voltage to a filament (62, 64) in the fluorescent lamp (60). A filament control input (12) turns on the cutout transistor (30) for a predetermined time period to preheat the filament (62, 64).

This invention relates generally to an electronic ballast circuit for starting and powering a gas-discharge or fluorescent lamp, and more particularly, to an improved starter circuit and an electronic ballast that shuts off filament current after starting a fluorescent lamp.

A fluorescent lamp is an evacuated glass tube internally coated with a mixture of phosphors. The tube contains purified gases such as argon or krypton and a small amount of mercury, some of which vaporizes at the low pressure. An electrical discharge filament or cathode at each end of the tube is heated with a filament voltage typically between four and ten volts. When the filaments are heated, electrons are emitted into the tube. A subsequent high voltage applied between the filaments causes ionization, the electrons conduct current, and a glow discharge is produced to emit ultraviolet light. This is then absorbed by the phosphors and re-emitted as visible light. The electric arc is conducted by a mixture of vaporized mercury and purified gases—mainly argon or krypton. Typical fluorescent lamps operate at alternating voltages ranging from 50 volts up to several hundred volts. The frequency of the lamp voltage is usually 50/60 Hz or above 20 kHz depending on the ballast design. Filaments constituting electrodes at opposite ends of the lamp alternately serve as cathodes in each frequency cycle.

The filaments are generally made from coiled tungsten wire coated with a material to increase the thermionic emission of electrons. During lamp operation, and particularly at startup, the emitter material can evaporate or sputter off the electrodes. The sputtering results in cumulative damage to one or more filaments, ultimately reducing emission below the minimum level. At this point, the lamp flickers or goes out, requiring replacement.

Fluorescent-lighting system circuits and related ballast designs in use today can be divided into four main starting-mode types: preheat start, instant start, rapid start, and programmed start.

Preheat lighting systems use separate starting switches across the lamp, commonly referred to as starters. The common type of starter in simple electromagnetic ballasts may be referred to as the glow-switch or glow-tube starter. After a period during which time the starter switch is closed and current runs through and heats the filaments, the switch opens abruptly. The attempt to open the inductive circuit causes a large voltage spike, which initiates a discharge or arc through the lamp. The filaments or cathodes require a few seconds to attain the proper operating temperature for starting.

While preheat lighting systems have the advantages of being widely used and low in cost, they may perform inconsistently, requiring the starting circuits to perform several starting cycles before the lamp can be lit, resulting in lamp blinking and delay of lighting. They also require a separate component—the starter. The preheat approach is typically used with 50/60 Hz ballasts, so the advantages of operating the lamp at higher frequency are not realized.

Instant-start lighting systems were first developed in the 1940s. Their ballasts require a much higher open circuit voltage, two to three times that of preheat systems, to initiate an arc. They may employ a boost converter in combination with a resonant inverter to provide an almost instantaneous ignition of the lamps with the high-frequency current, without requiring a filament heater. They need only one pin at each end of the lamp, although many varieties of bi-pin lamps also perform properly. Instant-start ballasts are typically lowest in cost and are best for applications in which lights will be left on for more than three hours at a time.

Rapid-start light systems, introduced in the 1950s, have a momentary delay from one to two seconds during starting. Rapid-start ballasts do not have starters. They employ a combination of preheating and relatively high voltage across the lamp to accomplish starting. The continuous lamp-filament heating after the lamps are started is an unwanted by-product of the preheating and wastes substantial power.

Ballasts employing rapid-start or instant-start circuits are particularly susceptible to filament deterioration due to sputtering of filament materials. Blackening of the tube ends appears after as few as several hundred on-off starts in lower-quality lamp/ballast combinations. However, either instant-start or rapid-start magnetic ballasts may be appropriate for settings where the equipment will operate in extreme temperature conditions or around sensitive electronic equipment, such as book-detection systems in libraries, inventory security systems in stores, recording studio equipment, and some electronic medical equipment. Because these ballasts operate at a much lower frequency than other electronic equipment, they are less likely to cause interference

Programmed-start electronic ballasts are designed to preheat the filaments of fluorescent lamps that are switched on and off frequently, for example, office lights controlled by occupancy sensors. The circuits of these ballasts precisely control pre-heating before the starting voltage is applied. A delay-triggered control circuit within the ballast delays ignition for a predetermined amount of time, usually between 0.5 seconds and two seconds, during which voltage is applied across each filament to sufficiently preheat and condition the filaments. Programmed-start circuits minimize filament stress and depletion of filament emissive material during the lamp-starting phase, thereby resulting in improved lamp life. The improved lamp efficiency that results from high-frequency operation is automatically realized.

An example of a programmed-start electronic fluorescent ballast that begins as if in a rapid-start mode and then removes the power for heating filaments is described in “Electronic Fluorescent Lamp Starter,” Nilssen, U.S. Pat. No. 4,603,281 issued Jul. 29, 1986. The ballast includes an electronic starter with a variable resistor that is connected in series with the primary winding of a current-transformer, and this series-combination is connected across the fluorescent lamp to be started. Before the lamp starts, the voltage across it is limited in magnitude by the voltage-clamping effect of the variable resistor, and the current flowing through the resistor is then transformed by the current-transformer and is applied by way of separate secondary windings to heat each of the filaments. A special high-voltage tertiary winding on the current-transformer provides additional voltage for starting the lamp.

A programmed-start electronic ballast for powering a fluorescent lamp is described in “Ballast Scheme for a Fluorescent Lamp with Preheated Filaments,” Garbowicz et al., U.S. Pat. No. 5,616,990 issued Apr. 1, 1997. Control circuitry within the ballast delays an igniter from being turned on until the filaments have been sufficiently preheated. The control circuitry is isolated and protected from the high voltage pulses of the igniter by an optocoupler. A bi-directional voltage triggered switch employed in the generation of the high voltage pulses is not relied upon for sensing full arc discharge of the lamp. The breakover voltage of the bi-directional voltage triggered switch can therefore be set at lower levels resulting in the generation of more high voltage pulses over a prefixed period of time.

An example of an electronic fluorescent-lamp ballast in a copy or facsimile machine that uses a switching mechanism and preheats the lamp filaments is described in “Apparatus for Operating a Fluorescent Lamp of an Image Forming Apparatus,” Sekiya, et al., U.S. Pat. No. 5,627,434 issued May 6, 1997. The device uses two power source circuits, the second power source circuit including a high frequency transformer having two or more outputs for supplying pre-heating electric currents to filaments. The first power source circuit controls the second power source circuit that supplies electric current to turn the lamp on. The electric power level for pre-heating the filaments is switched between a state where a light adjustment is performed by turning on/off a tube electric current at high frequency and a state where the fluorescent lamp is turned off in a standby mode.

A lamp with electrodes that can be heated during a preheat stage as well as in an ignited operation is described in “Gas Discharge Lamp Ballast with Heating Control Circuit and Method of Operating Same,” Luger et al., U.S. Pat. No. 5,656,891 issued Aug. 12, 1997. The circuitry, which includes an inverter with two switches in series, is particularly advantageous for a dimmable lamp, whereby the heating of the electrodes is dependant upon the degree of dimming of the light. The more strongly the lamp is dimmed, the more strongly the electrodes are heated.

A programmed-start electronic ballast with a delay-triggered circuit is described in “Fluorescent Lamp Electronic Ballast with Rapid Voltage Turn-On after Preheating,” Yang et al., U.S. Pat. No. 5,923,126 issued Jul. 13, 1999. After a predetermined period of time when the lamp filaments are preheated, the delay triggered circuit applies high-frequency operating voltage across the opposite electrodes of the lamp beginning with a rapid transition from a condition of no voltage to a condition of full-rated voltage within one cycle of the high frequency voltage. The ballast uses the same inverter and transformer for supplying preheating and operating voltages, which is applied between the opposite electrodes via an electronic bi-directional switch, controlled by a preheating delay resistor-capacitor timing circuit.

An electronic ballast that includes a voltage-controlled preheating circuit, an ignition-driver circuit, and power-controller circuitry is disclosed in “Electronic Ballast,” Pinchuk et al., U.S. Pat. No. 6,348,769 issued Feb. 19, 2002. Power-controller circuitry provides power to the pre-heating and ignition driver circuits in succession, so as to ignite the lamps. The power controller circuitry first provides power to the pre-heating circuit substantially at a first resonant frequency and subsequently provides power to the ignition driver circuit substantially at a second resonant frequency, by a smooth operating frequency transition from pre-heating to ignition.

An electronic ballast for a fluorescent lamp with a microprocessor that controls the closing of an AC switch while the lamp is starting and the opening of the switch after the lamp is started is disclosed in “Electronic Ballast with Filament Cut-Out,” Mirskiy et al., U.S. Pat. No. 5,973,455 issued Oct. 26, 1999. The switch cuts off the filaments from a source of power and reduces the power consumed by the ballast during normal operation. A resistor in series with the transistor is used to detect filament resistance and provide an indication of lamp type. Four diodes are used, adding to the complexity and cost of the ballast.

Increased energy efficiency and longer lamp life are perennial goals in the lighting industry. Thus an improved programmed-start ballast circuit would provide an electronic ballast that has higher efficiency than electronic ballasts of the prior art. When combined with programmed starting, filament cutout increases efficiency and makes complying with other important lamp specifications easier. Therefore, it is the intent of this invention to provide improved programmed-start circuitry, electronic ballasts for one or more fluorescent lamps, and associated operational method that would more precisely control the length of time that the filaments are preheated prior to and after lamp ignition. The improvements would save wasted energy that is expended by sustained heating of the lamp filaments after lamp ignition, would provide a simpler, more reliable and robust ignition scheme, and would extend lamp life, thereby overcoming the challenges and obstacles described above.

One aspect of the invention is a filament cutout circuit for a fluorescent lamp. The filament cutout circuit includes a filament transformer having a primary winding and at least one secondary winding, with a cutout transistor serially connected to the primary winding. The secondary winding provides a filament voltage to at least one filament in the fluorescent lamp. A filament control input turns on the cutout transistor for a predetermined time period to preheat the filament.

Another aspect of the invention is an electronic ballast for a fluorescent lamp, including a filament transformer with a primary winding and at least one secondary winding, a cutout transistor serially connected to the primary winding, and a fluorescent-lamp controller electrically connected to the cutout transistor. The secondary winding provides a filament voltage to at least one filament in the fluorescent lamp. The fluorescent-lamp controller sends a filament control signal that turns on the output transistor for a predetermined time period to preheat the filament.

Another aspect of the invention is a method of operating a fluorescent lamp. A filament control signal is received, and in response to that signal, a filament voltage is generated. The filament voltage is maintained for a predetermined time period sufficient to heat at least one filament in the fluorescent lamp prior to igniting the fluorescent lamp. The filament voltage is reduced upon expiration of the predetermined time period.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

Various embodiment of the present invention are illustrated by the accompanying figures, wherein:

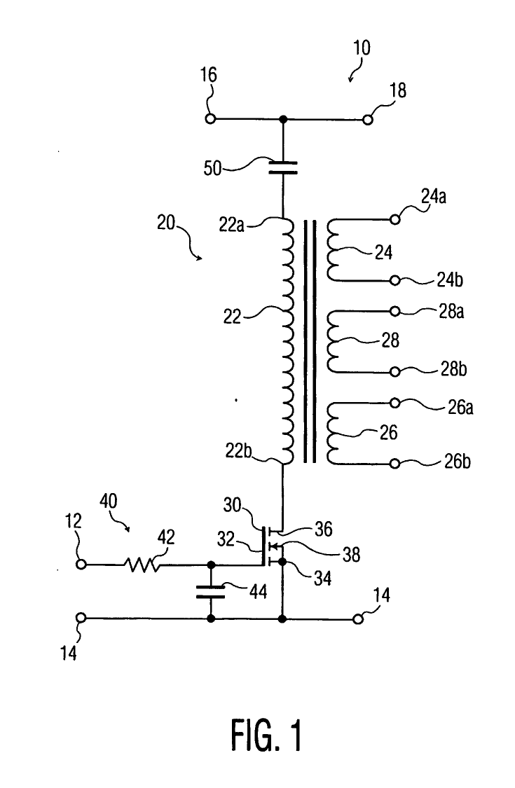

FIG. 1 is a schematic diagram of a filament cutout circuit for a fluorescent lamp, in accordance with one embodiment of the current invention;

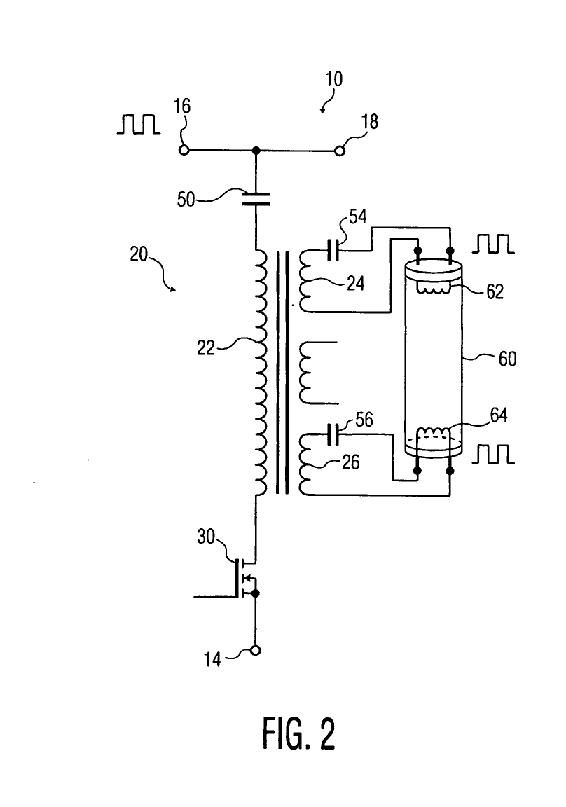

FIG. 2 is a schematic diagram of a portion of a filament cutout circuit connected to a fluorescent lamp, in accordance with one embodiment of the current invention;

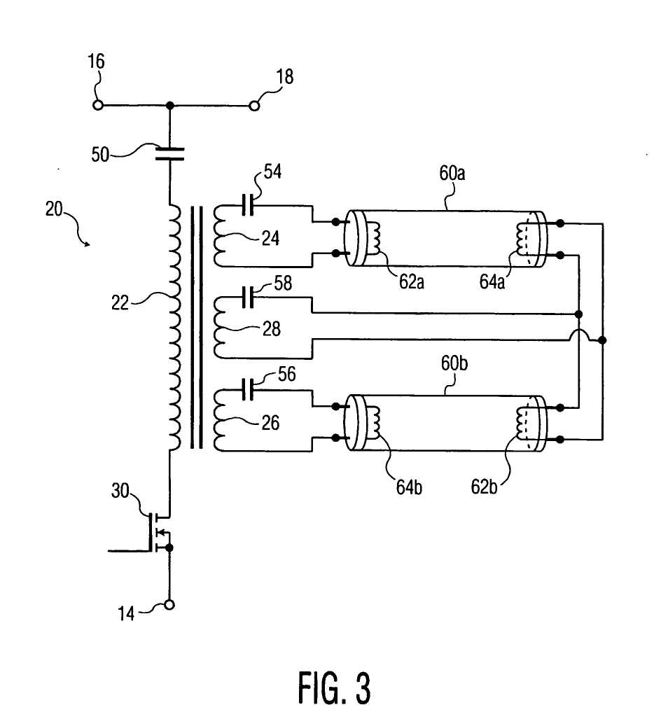

FIG. 3 is a schematic diagram of a portion of a filament cutout circuit connected to a pair of fluorescent lamps, in accordance with one embodiment of the current invention;

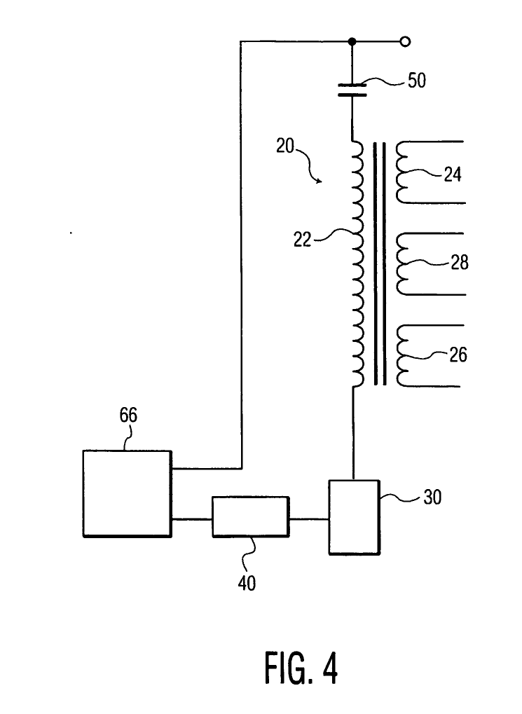

FIG. 4 is a block diagram of an electronic ballast for a fluorescent lamp, in accordance with one embodiment of the current invention;

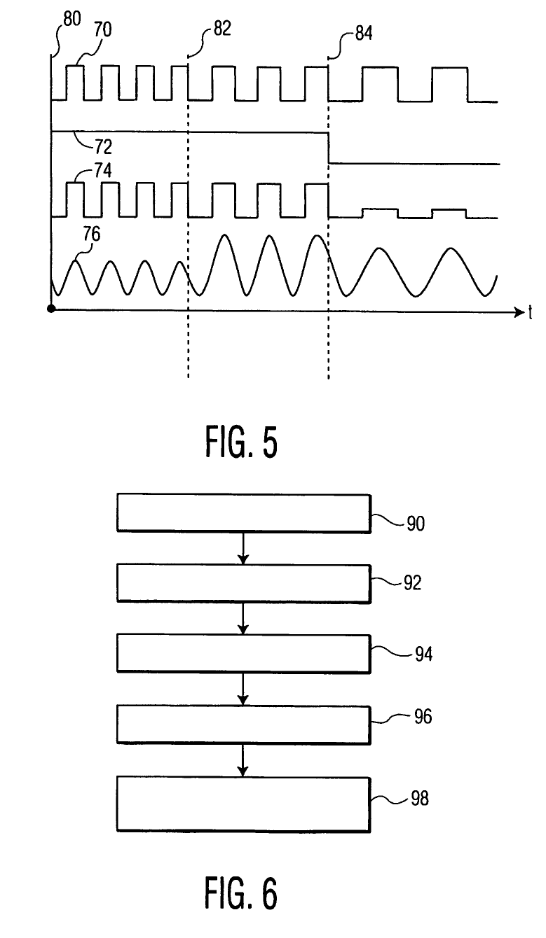

FIG. 5 is a timing diagram for an electronic ballast, in accordance with one embodiment of the current invention; and

FIG. 6 is a flow diagram of a method of operating a fluorescent lamp, in accordance with one embodiment of the current invention.

FIG. 1 shows a schematic diagram of a filament cutout circuit for a fluorescent lamp, in accordance with one embodiment of the present invention. Filament cutout circuit 10 includes a filament transformer 20 and a cutout transistor 30. Filament transformer 20 includes a primary winding 22 and at least one secondary winding 24, 26 and 28. Cutout transistor 30 is serially connected to one leg of primary winding 22. Secondary windings 24, 26, or 28 can provide a filament voltage to a filament in one or more fluorescent lamps.

Filament transformer 20 is typically a ferrite core transformer with primary winding 22 electrically connected to a power source such as an alternating frequency from an inverter, also referred to as a switching power supply, that provides a square-wave output. Filament transformer 20 of filament cutout circuit 10 typically receives a variable-frequency square-wave output from a switching power supply with a nominally 50-percent duty cycle, although rectangular and other waveform shapes can be received with varying duty cycles. A first secondary winding 24 has ends 24a and 24b that can be electrically connected to a first filament of a fluorescent lamp. A second secondary winding 26 has ends 26a and 26b that can be electrically connected to a second filament of the fluorescent lamp.

In another embodiment, first secondary winding 24 is electrically connected to a first filament of a fluorescent lamp, second secondary winding 26 is electrically connected to a second filament of a second fluorescent lamp, and a third secondary winding 28 with ends 28a and 28b is electrically connected to a second filament of the first fluorescent lamp and to a first filament of the second fluorescent lamp.

Cutout transistor 30 is typically a power transistor such as a power metal-oxide-semiconductor field-effect transistor (MOSFET) or a bipolar transistor. For the case of a power MOSFET, a gate electrode 32 receives a filament control signal at a filament control input 12 to turn on cutout transistor 30. When turned on, current can flow between a source electrode 34 and a drain electrode 36. A body electrode 38 is internally or externally connected to source electrode 34. Source electrode 34 is typically connected to a circuit ground 14, and drain electrode 36 is typically connected in series to end 22b of primary winding 22.

Filament control input 12 is electrically connected to cutout transistor 30. Filament control input 12 may receive a filament control signal from, for example, an interval timing circuit, a fluorescent-lamp controller, or a fluorescent-lamp controller with an interval timing circuit.

A cutout-transistor biasing network 40 is electrically connected to cutout transistor 30, providing proper bias for turning on and turning off cutout transistor 30. In one example, cutout-transistor biasing network 40 consists of a bias resistor 42 that is electrically connected between filament control input 12 and gate electrode 32, and a bias capacitor 44 that is electrically connected between gate electrode 32 and source electrode 34 of cutout transistor 30. This cutout-transistor biasing network 40 can turn cutout transistor 30 on and off properly even with high voltage ramp rates applied to primary winding 22 of filament transformer 20. When filament control input 12 is sufficiently high, cutout transistor 30 turns on so current can flow through primary winding 22. As filament control input 12 is lowered or reduced to near zero voltage after a predetermined period of time to preheat the filament, cutout transistor 30 turns off, reducing or eliminating any current flow through primary winding 22.

A blocking capacitor 50 is often connected in series between one end 22a of primary winding 22 and an inverter or switching power-supply input 16 to level shift and prevent saturation of filament transformer 20 when supplied, for example, with a positive-going transformer input supply such as zero to 240 volts or zero to 480 volts.

To supply a sufficiently high voltage to ignite and sustain an arc or discharge within the fluorescent lamp, ballast output 18 is connected to one end of the fluorescent lamp, and circuit ground 14 is connected to the other end of the fluorescent lamp. An additional blocking capacitor and an inductor are generally connected serially between ballast output 18 and the first end of the fluorescent lamp, such as one of the filament pins at one end of the fluorescent lamp. An additional shunt capacitor, not shown in the schematic, may be electrically connected between ballast output 18 and circuit ground 14.

In one example, filament transformer 20 comprises N+1 windings, where N is the number of unique filament connections. That is, N=2 for a ballast designed to operate one fluorescent lamp with two filaments, and N=3 for a ballast designed to operate two fluorescent lamps in series with yellow filaments driven from one transformer winding. Filament transformer 20 also has a primary winding, which is connected to the ballast inverter through a DC blocking capacitor 50 to prevent saturation. End 22b of primary winding 22 connects to a MOSFET cutout transistor 30. Gate electrode 32 of the MOSFET is kept high, on the order of 10-13 volts, during the preheat time, allowing the MOSFET to conduct. Filament transformer 20 delivers voltage to the filaments. After ignition is complete, the MOSFET gate voltage drops less than one volt, switching the entire filament transformer circuit off to limit filament dissipation to levels similar to instant-start ballasts.

Current sensitivity of filament control input 12 requires careful control. In this example, a resistive gate-to-source bypass cannot be used for the MOSFET. Bias capacitor 44 is used instead. Bias capacitor 44 is used because otherwise fast voltage rises from drain to gate would bias gate electrode 32 to an on-state, allowing partial MOSFET conduction and increasing losses. A 22 nF capacitance is sufficient in this case, with a 10 kilohm bias resistor 42.

FIG. 2 shows a schematic diagram of a portion of a filament cutout circuit connected to a fluorescent lamp, in accordance with one embodiment of the present invention. Filament cutout circuit 10 includes a filament transformer 20 and a cutout transistor 30. A blocking capacitor 50 is serially connected between a switching power-supply input 16 and a primary winding 22 of filament transformer 20. A ballast output 18 is typically connected to one end of a fluorescent lamp 60 through another blocking capacitor and an inductor. A secondary winding 24 of filament transformer 20 is connected to a first filament 62 of fluorescent lamp 60. A second winding 26 of filament transformer 20 is connected to a second filament 64 of fluorescent lamp 60. Filament capacitors 54 and 56 may be placed in the loop between ends of secondary windings 24 and 26 and filaments 62 and 64, respectively. A circuit ground 14 may be connected to fluorescent lamp 60 at one of the filament pins at an opposite end of the connection for ballast output 18.

FIG. 3 shows a schematic diagram of a portion of a filament cutout circuit connected to a pair of fluorescent lamps, in accordance with one embodiment of the present invention. Similar to the single tube configuration of FIG. 2, a switching power-supply output is connected to a switching power-supply input 16, providing an excitation voltage to a primary winding 22 of a filament transformer 20 through a blocking capacitor 50. A cutout transistor 30 is connected in series with primary winding 22 and a circuit ground 14.

Fluorescent lamps 60a and 60b represent, in one example, widely available T5 or T8 fluorescent lamps in lengths such as two feet, four feet, six feet or eight feet, and with wattages between, for example, 14 watts and 80 watts. In this dual lamp depiction, filament 62a of fluorescent lamp 60a is connected to secondary winding 24 of filament transformer 20, filament 64b of fluorescent lamp 60b is connected to secondary winding 26 of filament transformer 20, and filaments 64a and 62b are connected to secondary winding 28 of filament transformer 20. Filament capacitors 54, 56 and 58 may be inserted between one of the ends of the secondary windings and a filament pin. Secondary winding 28 may be connected to filament 64a and filament 62b in a parallel filament configuration as shown, or in a series filament configuration. Ballast output 18 and circuit ground 14 are generally connected through an additional blocking capacitor and an inductor to filaments 62a and 64b to ignite the lamps and to sustain an arc within fluorescent lamp 60a and 60b. In one example, blocking capacitor 50 has a value of 47 nF, filament capacitors 54 and 56 have a value of 180 nF, and filament capacitor 58 has a value of 330 nF.

FIG. 4 shows a block diagram of an electronic ballast for a fluorescent lamp, in accordance with one embodiment of the present invention. The electronic ballast includes a filament transformer 20, a cutout transistor 30, and a fluorescent-lamp controller 66. Filament transformer 20 includes a primary winding 22 and at least one secondary winding 24, 26 and 28. Cutout transistor 30, which may be a power MOSFET, a power bipolar transistor or other suitable switching device, is serially connected to primary winding 22. Fluorescent-lamp controller 66 includes an interval timing circuit or an equivalent thereof to provide a filament control signal to the filament control input. Fluorescent-lamp controller 66 sends the filament control signal to cutout transistor 30 that turns on cutout transistor 30 for a predetermined time period to preheat a filament with a filament voltage from a secondary winding of filament transformer 20.

Fluorescent-lamp controller 66 may provide other functions, such as generating and controlling a switching power supply or an inverter at a predetermined frequency while the filaments in the fluorescent lamp are being heated, then smoothly shifting the inverter frequency closer to a resonant peak of the output tank circuit so that a higher voltage is generated across the fluorescent lamp to strike and maintain a discharge. Fluorescent-lamp controller 66 may contain circuitry and programming to detect the filaments and to control filament and lamp voltages during lamp operation. In one example, fluorescent-lamp controller 66 provides a filament voltage for a predetermined period of time that includes time to adequately heat the filament and ignite the lamp with additional time for margin. Alternatively, an interval timing circuit such as a one-shot signal generator may be electrically connected to the cutout transistor and used to generate the filament control signal and provide the filament control signal to the filament control input.

The electronic ballast may include a cutout-transistor biasing network 40 electrically connected to cutout transistor 30. The cutout-transistor biasing network consists of, for example, a bias resistor connected between the filament control input and a gate electrode of cutout transistor 30, and a bias capacitor connected between the gate electrode and a source electrode of the cutout transistor. Additionally, a blocking capacitor 50 may be serially connected between a switching power-supply input and a primary winding 22 of filament transformer 20.

Secondary windings 24 and 26 may be connected to a first filament and a second filament at the ends of a fluorescent lamp. In a dual-lamp configuration, secondary windings 24 and 26 are connected to a first filament of a first fluorescent lamp and to a second filament of a second fluorescent lamp, with a third secondary winding 28 connected to a second filament of the first fluorescent lamp and to a first filament of the second fluorescent lamp either in a series filament configuration or a parallel filament configuration.

FIG. 5 shows a timing diagram for an electronic ballast, in accordance with one embodiment of the present invention. The timing diagram qualitatively shows signals at various points in the electronic ballast at different times of interest.

In this example, power to the electronic ballast is switched on at a starting point 80. A switching power-supply output 70 is generated by a fluorescent-lamp controller at a first frequency set well above a resonant frequency of the electronic ballast output tank circuit. For example, the first frequency may be at 70-85 kHz. At this frequency, the voltage applied to the ends of the fluorescent lamp is appreciably below an ignition voltage, and may be on the order of 100 volts. During the filament preheat stage, a filament control signal 72 from the fluorescent-lamp controller or a timing circuit is generated to turn on a cutout transistor in series with the primary of a filament transformer. Filament control signal 72 may have an on voltage, for example, between ten and thirteen volts. A filament voltage 74 is generated at a sufficiently high voltage to adequately preheat the filaments, usually in the range between four and ten volts.

At a time 82 after the filament preheat stage, typically in the range of 800 to 900 milliseconds, a lamp-ignition stage is entered. The frequency of the switching power-supply output is decreased, typically to a frequency above, yet near to the resonant frequency of the output tank circuit. In one example, the frequency of the inverter is decreased to between 40 kHz and 60 kHz. The lamp voltage then increases, in some cases greater than a factor of four, to ignite the lamps. Ignition voltages range from about 300 volts to 1000 volts. Separate protective circuitry (not shown) limits this voltage to a safe level in case of non-startable lamps. After a predetermined period of time 84, the filament voltage 74 is reduced or cut out by lowering the filament control signal 72 below a turnoff level of, for example, 0.75 volts, and turning off the cutout transistor. Lamp voltage 76 remains at a high level but below ignition voltage. Once the lamp ignites, a portion of each filament is automatically kept at emission temperature. This results from the normal arc current crowding into a small spot due to the negative-resistance characteristics of electron emission.

FIG. 6 is a flow diagram of a method for operating a fluorescent lamp, in accordance with one embodiment of the present invention. The fluorescent-lamp operation method includes steps to ignite and sustain ignition of a fluorescent lamp such as commercially available T5 or T8 fluorescent lamps.

Power to an electronic ballast is switched on, as seen at block 90. The power may be switched on, for example, by depressing a switch that applies line voltage to the electronic ballast or by triggering a motion detector that detects movement in a room.

A filament control signal is received, as seen at block 92. The filament control signal is received from, for example, a timing circuit or a fluorescent-lamp controller. The control signal is typically at a sufficiently high voltage to turn on a cutout transistor connected in series with the primary winding of a filament transformer.

A filament voltage is generated, as seen at block 94. The filament voltage is generated in response to the filament control signal. In one example, the filament control signal turns on the cutout transistor connected in series with a primary winding of a filament transformer, and a filament voltage is generated at one or more secondary windings. The voltage to the primary winding is generated by a variable-frequency switching power supply or inverter, and the frequency of the switching power supply is selected to be off-resonance so that the lamp voltage is relatively small and the filament voltage is sufficiently high to warm up the filaments.

The filament voltage is maintained for a predetermined period of time that is sufficient to heat one or more filaments in the fluorescent lamp, as seen at block 96. The filament voltage is maintained prior to igniting the fluorescent lamp. The filament voltage heats the filaments to an emission temperature where electrons are cathodically emitted from the surface of the filaments. As the filaments warm up, the ability to ignite an arc inside the fluorescent lamp increases.

After the filaments are suitably heated, the fluorescent lamp ignites and the filament voltage is reduced, as seen at block 98. Ignition of the fluorescent lamp may be achieved by raising the lamp voltage, which may occur, for example, when the frequency of the lamp voltage is adjusted closer to a resonant frequency of the lamp output circuit, thereby increasing the lamp voltage. The filament voltage is reduced upon expiration of the predetermined time period. Typically, the predetermined time period is set to an amount of time that allows ignition of the fluorescent lamp with an adequate margin of time for variability prior to reducing the filament voltage. The filament voltage may be reduced, for example, by turning off the cutout transistor in series with the primary of the filament transformer. The filament voltage is reduced or cut out, saving power surplus to actual operating filament needs. As the generated arc continues, at least a portion of each filament stays hot enough to boil off electrons and sustain the arc as desired.

The arc is sustained and the fluorescent lamp stays lit until power is removed or the fluorescent lamp is disconnected from the electronic ballast. When power is reapplied or the fluorescent lamp is replaced, the methods steps for generating a filament voltage and igniting the lamp may be repeated.

Multiple fluorescent lamps can be started with the electronic ballast, by using additional secondary windings on the filament transformer, or by placing the fluorescent lamps in series or parallel configurations.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A filament cutout circuit for a fluorescent lamp (60), comprising:
a filament transformer (20) including a primary winding (22) and at least one secondary winding (24, 26, 28); and
a cutout transistor (30) serially connected to the primary winding (22); wherein the secondary winding (24, 26, 28) provides a filament voltage to at least one filament (62, 64) in the fluorescent lamp (60) and wherein a filament control input (12) turns on the cutout transistor (30) for a predetermined time period to preheat the filament (62, 64).

2. The circuit of claim 1 wherein the cutout transistor (30) comprises a power metal-oxide-semiconductor field-effect transistor.

3. The circuit of claim 1 wherein the at least one secondary winding (24, 26) comprises a first secondary winding (24) connected to a first filament (62) of the fluorescent lamp (60) and a second secondary winding (26) connected to a second filament (64) of the fluorescent lamp (60).

4. The circuit of claim 1 wherein the at least one secondary winding (24, 26, 28) comprises a first secondary winding (24) connected to a first filament (62a) of a first fluorescent lamp (60a), a second secondary winding (26) connected to a second filament (64b) of a second fluorescent lamp (60b), and a third secondary winding (28) connected to a second filament (64a) of the first fluorescent lamp (60a) and a first filament (62b) of the second fluorescent lamp (60b).

5. The circuit of claim 4 wherein the third secondary winding (28) is connected to the second filament (64a) of the first fluorescent lamp (60a) and the first filament (62b) of the second fluorescent lamp (60b) in one of a series filament configuration or a parallel filament configuration.

6. The circuit of claim 1 further comprising:
a cutout-transistor biasing network (40) electrically connected to the cutout transistor (30).

7. The circuit of claim 6 wherein the cutout-transistor biasing network (40) consists of a bias resistor (42) connected between the filament control input (12) and a gate electrode (32) of the cutout transistor (30), and a bias capacitor (44) connected between the gate electrode (32) and a source electrode (34) of the cutout transistor (30).

8. The circuit of claim 1 further comprising:
an interval timing circuit electrically connected to the cutout transistor (30), the interval timing circuit providing a filament control signal to the filament control input (12).

9. The circuit of claim 1 further comprising:
a blocking capacitor (50), wherein the blocking capacitor (50) is serially connected between a switching power-supply input (16) and the primary winding (22) of the filament transformer (20).

10. An electronic ballast for a fluorescent lamp (60) comprising:
a filament transformer (20) including a primary winding (22) and at least one secondary winding (24, 26, 28);
a cutout transistor (30) serially connected to the primary winding (22); and
a fluorescent-lamp controller (66) electrically connected to the cutout transistor (30); wherein the secondary winding (24, 26, 28) provides a filament voltage to at least one filament (62, 64) in the fluorescent lamp (60) and wherein the fluorescent-lamp controller (66) sends a filament control signal that turns on the cutout transistor (30) for a predetermined time period to preheat the filament (62, 64).

11. The electronic ballast of claim 10 wherein the cutout transistor (30) comprises a power metal-oxide-semiconductor field-effect transistor.

12. The electronic ballast of claim 10 wherein the at least one secondary winding (24, 26) comprises a first secondary winding (24) connected to a first filament (62) of the fluorescent lamp (60) and a second secondary winding (26) connected to a second filament (64) of the fluorescent lamp (60).

13. The electronic ballast of claim 10 wherein the at least one secondary winding (24, 26, 28) comprises a first secondary winding (24) connected to a first filament (62a) of a first fluorescent lamp (60a), a second secondary winding (26) connected to a second filament (64b) of a second fluorescent lamp (60b), and a third secondary winding (28) connected to a second filament (64a) of the first fluorescent lamp (60a) and a first filament (62b) of the second fluorescent lamp (60b).

14. The electronic ballast of claim 13 wherein the third secondary winding (28) is connected to the second filament (64a) of the first fluorescent lamp (60a) and the first filament (62b) of the second fluorescent lamp (60b) in one of a series filament configuration or a parallel filament configuration.

15. The electronic ballast of claim 10 further comprising:
a cutout-transistor biasing network (40) electrically connected to the cutout transistor (30).

16. The electronic ballast of claim 15 wherein the cutout-transistor biasing network (40) consists of a bias resistor (42) connected between the filament control input (12) and a gate electrode (32) of the cutout transistor (30), and a bias capacitor (44) connected between the gate electrode (32) and a source electrode (34) of the cutout transistor (30).

17. The electronic ballast of claim 10 further comprising:
a blocking capacitor (50), wherein the blocking capacitor (50) is serially connected between a switching power-supply input (16) and the primary winding (22) of the filament transformer (20).

18. A method of operating a fluorescent lamp (60), comprising:
receiving a filament control signal;
generating a filament voltage responsive to the filament control signal;
maintaining the filament voltage for a predetermined time period sufficient to heat at least one filament (62, 64) in the fluorescent lamp (60) prior to igniting the fluorescent lamp (60); and
reducing the filament voltage upon expiration of the predetermined time period.

19. The method of claim 18 wherein the filament control signal is received from an interval timing circuit.

20. The method of claim 18 wherein the filament control signal is received from a fluorescent-lamp controller (66).

21. A filament cutout circuit for a fluorescent lamp, the filament cutout circuit comprising:
a filament transformer including a primary winding and at least one secondary winding,
wherein the secondary winding provides a filament voltage to at least one filament in the fluorescent lamp and wherein the filament voltage has a fixed polarity; and
a cutout transistor connected to the primary winding,
wherein a filament control input turns on the cutout transistor for a predetermined time period to preheat the filament during consecutive cycles of an application of a switching power supply to the primary winding.

22. The filament cutout circuit of claim 1, wherein the transistor and the primary winding are serially connected whereby the filament voltage has a fixed polarity.

23. The filament cutout circuit of claim 21, wherein the cutout transistor includes:
a power metal-oxide-semiconductor field-effect transistor.

24. The filament cutout circuit of claim 21, wherein the at least one secondary winding includes:
a first secondary winding connected to a first filament of the fluorescent lamp; and
a second secondary winding connected to a second filament of the fluorescent lamp.

25. The filament cutout circuit of claim 21, wherein the at least one secondary winding includes:
a first secondary winding connected to a first filament of a first fluorescent lamp;
a second secondary winding connected to a second filament of a second fluorescent lamp; and
a third secondary winding connected to a second filament of the first fluorescent lamp and a first filament of the second fluorescent lamp.

26. The filament cutout circuit of claim 25, wherein the third secondary winding is connected to the second filament of the first fluorescent lamp and the first filament of the second fluorescent lamp in one of a series filament configuration or a parallel filament configuration.

27. The filament cutout circuit of claim 21, further comprising:
a cutout-transistor biasing network electrically connected to the cutout transistor.

28. The filament cutout circuit of claim 27, wherein the cutout-transistor biasing network includes:
a bias resistor connected between the filament control input and a gate electrode of the cutout transistor; and
a bias capacitor connected between the gate electrode and a source electrode of the cutout transistor.

29. The filament cutout circuit of claim 21, further comprising:
an interval timing circuit electrically connected to the cutout transistor,
wherein the interval timing circuit provides a filament control signal to the filament control input.

30. The filament cutout circuit of claim 21, further comprising:
a blocking capacitor,
wherein the blocking capacitor is connected between a switching power-supply input and the primary winding of the filament transformer.

31. An electronic ballast for a fluorescent lamp, the electronic ballast comprising:
a filament transformer including a primary winding and at least one secondary winding,
wherein the secondary winding provides a filament voltage to at least one filament in the fluorescent lamp and wherein the filament voltage has a fixed polarity;
a cutout transistor connected to the primary winding; and
a fluorescent-lamp controller electrically connected to the cutout transistor,
wherein the fluorescent-lamp controller sends a filament control signal that turns on the cutout transistor for a predetermined time period to preheat the filament during consecutive cycles of an application of a switching power supply to the primary winding.

32. The electronic ballast circuit of claim 31, wherein the transistor and the primary winding are serially connected whereby the filament voltage has a fixed polarity.

33. The electronic ballast of claim 31, wherein the cutout transistor includes a power metal-oxide-semiconductor field-effect transistor.

34. The electronic ballast of claim 31, wherein the at least one secondary winding includes:
a first secondary winding connected to a first filament of the fluorescent lamp; and
a second secondary winding connected to a second filament of the fluorescent lamp.

35. The electronic ballast of claim 31, wherein the at least one secondary winding includes:
a first secondary winding connected to a first filament of a first fluorescent lamp;
a second secondary winding connected to a second filament of a second fluorescent lamp; and
a third secondary winding connected to a second filament of the first fluorescent lamp and a first filament of the second fluorescent lamp.

36. The electronic ballast of claim 35, wherein the third secondary winding is connected to the second filament of the first fluorescent lamp and the first filament of the second fluorescent lamp in one of a series filament configuration or a parallel filament configuration.

37. The electronic ballast of claim 31, further comprising:
a cutout-transistor biasing network electrically connected to the cutout transistor.

38. The electronic ballast of claim 37, wherein the cutout-transistor biasing network includes:
a bias resistor connected between the filament control input and a gate electrode of the cutout transistor; and
a bias capacitor connected between the gate electrode and a source electrode of the cutout transistor.

39. The electronic ballast of claim 31, further comprising:
a blocking capacitor,
wherein the blocking capacitor is connected between a switching power-supply input and the primary winding of the filament transformer.

40. A method of operating a fluorescent lamp, the method comprising:
generating a filament voltage sufficient to heat at least one filament in the fluorescent lamp prior to igniting the fluorescent lamp,
wherein the filament voltage is generated for a predetermined time period during consecutive cycles of an application of a switching power supply to the fluorescent lamp, and
wherein the filament voltage has a fixed polarity; and
reducing the filament voltage upon expiration of the predetermined time period.
